(19) United States
(12) Patent Application Publication
(10) Pub. No.: US 2016/0370774 A1
(43) Pub. Date: Dec. 22, 2016

(54) PROCESS FOR CONTROLLING A MOBILE DEVICE

(71) Applicant: Universite du Sud - Toulon - Var Universite du Sud - Toulon - Var, LA GARDE CEDEX (FR)

(72) Inventors: Hachem Amine LAMTI, TOULON (FR); Philippe GORCE, LA VALETTE (FR); Mohamed Moncef BEN KHELIFA, Pierrefeu du Var (FR)

(21) Appl. No.: 14/741,950

(22) Filed: Jun. 17, 2015

(51) Int. Cl. G05B 15/02; A61G 5/04

(52) U.S. Cl. CPC G05B 15/02; A61G 5/04

(57) ABSTRACT

A method of commanding and controlling a mobile apparatus (wheelchair) based on the assimilation of visual parameter and brain activity data includes validating a desired position of gaze (the iris) in the environment using the physiological brain characteristics of the potentials mentioned in P300 and SSVEP. These supply a control unit and are used to assess the user's state of mental fatigue using an algorithm based on the theory of evidence. A unit detecting the user's emotional state is also implemented using the alpha and beta waves from the parietal, central and frontal region of the cerebral cortex and the user's heart rhythm. The assimilation between these two units makes it possible to define a mode of operation in real time: manual, semi-autonomous or autonomous, which corresponds to the user's emotional or fatigue states as well as the characterization of the environment (safe path, detection of obstacles, locked situation).

### FIELD OF THE INVENTION

The present invention more particularly relates to the control of a mobile apparatus taking into account brain data.

A preferred application relates to the industry of wheelchairs for disabled persons.

TECHNOLOGICAL BACKGROUND

Most of the current mobile apparatus are controlled by partially mechanical controls. A user must thus use a joystick, a wheel, a bar, or any other manual control system to steer a mobile apparatus. Unfortunately, such apparatus cannot be used by some persons, specifically tetraplegic persons. New means for controlling a mobile apparatus may be interesting to even non tetraplegic persons. This could more particularly enable the user to use his/her limbs for other tasks, not related to the control of the mobile apparatus. A need thus exists for a technical solution for controlling a apparatus, without any mechanical control.

As regards this latter field, the solution disclosed in document CN103263324 is known. Such solution makes it possible to control a wheelchair using brain data of the SSVEP (Steady-State Visual-Evoked Potentials) type (or PEVRP (Potentiel Evoqué Visuel de Régime Permanent) in French). Such technique makes it possible to control said wheelchair using an analysis of the brain waves emitted by the user upon a stimulation of his/her eyes by a specific frequency (from 5 Hz). A continuous or harmonic frequency response is generated at the visual region of the cerebral cortex with the same frequency of occurrence of the stimulus. Once the match is established between a specific light frequency and the answer thereto by the brain, the image visualized by the user's eye can be determined, by analysing an electroencephalography (EEG) Sensors detecting the obstacles are provided on the wheelchair to enhance the user's safety.

Such solution has some disadvantages. As a matter of fact, controlling a mobile apparatus using visual controls is difficult and tiring. This results in a visual saccade, a sporadic focussing of the eye and a reduced reliability of the control. The motions of the apparatus are thus less precise, the user's safety is not optimum, and the user's exhaustion makes an extended use impossible.

A need therefore exists, which consists in providing a solution making it possible to eliminate, or at least reduce some of the above-mentioned drawbacks.

### SUMMARY OF THE INVENTION

One aspect of the invention more particularly relates to a method for is controlling the motion of a mobile apparatus by a user, wherein the motion control is based on a motion directive, with said motion directive comprising a path directive and a speed directive, comprising a step of determining said motion instruction.

This method is advantageously so designed that the step of determination comprises the following steps, implemented by a computer using at least one microprocessor:
Generation of at least one motion instruction 206 based at least on:
   at least one direction 203 originating from the user's gaze point 103,
   at least one first user's brain data, with said brain data originating from a user's positive brain wave, also called P300 brain wave 101, which appears 300 ms (millisecond) after a stimulation and/or originating from a user's brain wave, also called SSVEP brain wave 102, which appears in response to a predetermined visual stimulation;
Generation of at least one control data 340, at least based on:
   a second user's brain data originating from a P300 brain wave 101, and/or originating from a SSVEP brain wave 102 and/or a brain wave of the alpha and/or beta type 112 at the parietal, central and frontal region of the cerebral cortex.
   a physiological data among at least the user's temperature 105 and/or heart rhythm 104;
Generation of at least one environment data 412 from at least one sensor identifying at least one part of the environment of the mobile apparatus;
Generation of a motion directive 500 according to at least: said motion instruction 206, said control data 340 and said environment data 412.
Generation of a path directive 520 and a speed directive 510 is according to said motion instruction, specifically.

Such provision enables to control a mobile apparatus, taking into account visual, cerebral and physiological data. Said user is then assisted in controlling the apparatus, which significantly reduces the fatigue resulting from the use thereof. Besides, the user's safety is enhanced if the environment is taken into consideration. The user's motion instruction is thus first validated by his/her brain data, which makes it possible to avoid undesirable motions. Besides, such motion instruction is assimilated with control data originating from brain and physiological data. Such control data makes it possible to still sharpen the user's will or non-will while taking into account data such as stress or fatigue.

The general control of the apparatus thus becomes less tiring, safer and more precise.

The invention also relates to a mobile apparatus, the motion of which is controlled through the method.

Such apparatus advantageously comprises various types of sensors so configured as to detect at least one data according to a user's gaze point, brain data and physiological data, as well as space data.

Such solution makes it possible to collect the data required for a correct implementation of the method. Operating the mobile apparatus thus becomes easier and less tiring thanks to such sensors.

### BRIEF DESCRIPTION OF THE FIGURES

Other characteristics, aims and advantages of the present invention will appear upon reading the following detailed description and referring to the appended drawings given as non-limiting examples and wherein:

FIG. 1 is a flowchart showing the general operation of the method for controlling the mobile apparatus.

FIG. 2 shows in greater details the method for determining a brain data of the P300 type according to a P300 brain wave;

FIG. 3 shows in greater details the method for determining a brain data of the SSVEP type according to a SSVEP brain wave;

FIG. 4 shows the method for validating the direction using the P300 and SSVEP brain data;

FIG. 5 shows the method for determining the gaze point activation thresholds;

FIG. 6 shows in greater details the method for the fuzzy logic to assimilate the P300 and SSVEP data for validating the direction.

FIG. 7 represents the method for determining the user's emotional state;

FIG. 8 represents the method for determining the user's fatigue state;

FIG. 9 discloses the taking into account of multiple data by the fuzzy logic in order to determine the environment data;

FIG. 10 is a graph showing the transcription of speed in degree of membership in the fuzzy logic.

FIG. 11 is a graph showing the transcription of the amplitude deviations in degree of membership in the fuzzy logic.

FIG. 12 shows the grid which the user can see to determine the direction;

FIG. 13 shows a top view of the mobile apparatus;

FIG. 14 shows a side view of the mobile apparatus;

### DETAILED DESCRIPTION

Prior to going into details relating to the preferred embodiments of the invention while referring more particularly to the drawings, other optional characteristics of the invention which may be implemented in any combination or alternately, are mentioned hereafter:
the motion instruction determines a path instruction among at least one or a combination of the following directions: forward, backward, right, left, stop, with the path directive depending on the path instruction too.
said step of generating the motion instruction comprises a validation of the at least one direction selected by the user through the at least one first brain data, so as to determine the path instruction.
the first and/or second brain data originates from a P300 brain wave and comprises a step of generating the first and/or second brain data originating from the P300 brain wave, comprising the following steps:
   Reading a user's brain activity while recording the control displaying time (CDT), and such reading is executed by electrodes distributed over the user's head.
   Detecting the P300 brain wave from the change in the amplitude of brain activity and recording the changing time (CT);
   Comparing CDT with CT;
   Generating the first and/or second brain data, called P300 brain data, originating from one P300 brain wave.
the motion instruction determines a path instruction, wherein said step of generating the motion instruction comprises the validation of the at least one direction selected by the user by the at least one brain data, in order to determine the path instruction, wherein said first brain data originates from a P300 brain wave, and wherein the step of validation by the at least one first brain data, comprises the following steps:
   If the difference between CT and CDT+300 ms (10⁻³ seconds) is less than or equal to 100ms the path instruction is then transmitted to the motion directive with a validated status;
   If the difference between CT and CDT+300 ms is more than 100 ms the path instruction is then transmitted to the motion directive with a pending status;
the first and/or second brain data originates from a SSVEP brain wave and comprises a step of generating the first and/or second brain data originating from the SSVEP brain wave, comprising the following steps:
   Appearing of controls with pre-set frequencies (between 10 and 25 Hz) (CDF);
   Detecting the change in the amplitude of the brain activity and recording the change frequency (CF) with such reading being executed by electrodes distributed over the user's head.
   Comparing CDF with CF;
   Generating the first and/or second brain data, also called SSVEP brain data, originating from one SSVEP brain wave.
the motion instruction determines a path instruction, wherein said step of generating the motion instruction comprises the validation of the at least one direction selected by the user by the at least one first brain data, in order to determine the path directive, wherein said first brain data originates from a SSVEP brain wave, and wherein the step of validation by the at least one first brain data, comprises the following steps:
   If the difference between CF and CDF is less than or equal to 10% the path directive is then transmitted to the motion directive with a validated status;
   If the difference between CF and CDF is more than 10% the path directive is then transmitted to the motion directive with a pending status;
the step of generating the motion instruction comprises the validation of the at least one direction originating selected by the user and wherein the first and/or second brain data originates from a P300 brain wave and is called P300 brain data and wherein the first and/or second brain data originates from a SSVEP brain wave and is called a SSVEP brain data, with said validation occurring according to the at least one P300 brain data and the at least one SSVEP brain data, with the at least two P300 and SSVEP brain data being simultaneously taken into account by a fuzzy logic system.
A method comprising a step of selecting a control mode among the following ones: manual, semi-autonomous and autonomous, with the is motion directive depending specifically on the selected control mode, with said selection of the control mode being based on said at least one control data.
generating at least one control data comprises determining a user's psychological and/or physiological state, with said psychological and/or physiological state depending on said user's emotional or fatigue states.
generating the first and/or second brain data, also called SSVEP brain data, originates from a SSVEP brain wave and/or generating the first and/or second brain data, also called P300 brain data originates from a P300 brain wave, and wherein the user's psychological and/or physiological state depends on a fatigue state, with said fatigue state being more particularly determined through the interpretation of the second brain data, with said second brain data being the P300 brain data and/or the SSVEP brain data.
the user's fatigue state is determined by a pre-determination originating from the at least one brain data of the P300 and/or SSVEP type, and by at least one data pre-recorded in a “fatigue” data base, and by applying the Dempster-Shafer theory (or theory of evidence) comprising the application of plausibility rules.
the at least second brain data originating from a P300 and/or SSVEP brain wave originates from the same P300 and/or SSVEP brain wave as the at least one first data.
the user's emotional state is determined according to said physiological data comprising the user's temperature and heart rhythm, and the at least second brain data originating from a brain wave of the beta and/or alpha type called the alpha and/beta brain wave, and at least one data pre-recorded in an “emotions” data base, with said determination being operated by a neural network.
the user's psychological and/or physiological state is generated by a fuzzy logic system taking into account the user's fatigue and/or emotional states.
the at least one sensor is so configured as to enable the detection of the distance between the apparatus and obstacles positioned close to the apparatus and/or to enable the localisation of the apparatus.
said environment data originates from several types of sensors and the data from each type of sensor are processed by a fuzzy logic system, the processed data being interpreted afterwards by a neural network making it possible to determine the location and/or the distance of the apparatus relative to the obstacles, as well as the number of obstacles surrounding said apparatus.
the user's at least first and second brain data are sensed by an EEG sensor (electroencephalography), so configured as to detect and/or record at least one user's P300 and/or SSVEP and/or alpha and/or beta brain wave.
A mobile apparatus comprising a screen so configured as to display a grid comprising directions.
each direction in the grid displays a different light frequency.
said at least one user's gaze point is sensed by an eye-tracking apparatus so configured as to sense and/or record the gaze point of at least one of the user's irises when the user looks at the screen.
the at least one user's physiological data originates from a thermometer and/or a heart-rate monitor so configured as to detect and record said user's temperature and heart rhythm, respectively.
the environment data originate from at least one ultrasonic sensor and from at least one motion sensor so configured as to localise the mobile apparatus as well as the distance thereof from the surrounding objects.
a mobile apparatus, having at least one front face, one rear face and two side faces, and wherein the ultrasonic sensors are ten in number and positioned as follows:
   two sensors on each one of the front and rear faces of the mobile apparatus;
   three sensors on each one of the side faces of the mobile apparatus;
which motion sensors are four in number and are positioned on each one of the front, rear and side faces of the mobile apparatus.

In order to enable a perfect understanding of the terms used in the present description, and unless otherwise mentioned, the following expressions will means:
brain wave of the P300 type; Brain activity linked to a stimulation and appearing 300 milliseconds (ms) after said stimulation.
brain wave of the SSVEP (Steady-State Visual-Evoked Potential) type or

PEVRP (Potentiel Evoqué de Régime Permanent) in French: brain activity in response to an eye stimulation. According to the light frequency detected by the eye, the brain emits a continuous or harmonic frequency response at the visual region of the cerebral cortex with the same frequency of occurrence of the stimulus.
Dempster-Shafer Theory or theory of evidence: The Dempster-Shafer Theory is a mathematical theory based on the notion of evidence using belief function and plausible reasoning. The aim of such theory is to make it possible to combine distinct proofs to calculate the probability of an event. Notions such as uncertainty or reliability can thus be taken into account.
Fuzzy logic system: Fuzzy logic is an extension of conventional logic which makes it possible to modelize data imperfections based on the concept of fuzzy sets. It may contain elements which only have a partial degree of membership and somehow is close to the flexibility of human reasoning. Fuzzy logic is for instance described in the following publication: Multisensor data fusion: A review of the state-of-the-art, Bahador Khaleghi, Alaa Khamis, Fakhreddine 0. Karray information fusion journal, 2011
Neural networks: A neural network is a computational model the conception of which is inspired from the operation of biological neurons. They are optimised by learning methods. They belong to the family of artificial intelligence methods which they provide with a perceptive mechanism which does not depend on the implementer's own ideas, and providing the formal logic reasoning with input information. Neural networks are described in the following publication: Rifai Chai; Sai Ho Ling; Hunter, G. P.; Tran, Y.; Nguyen, H. T., “Brain-Computer Interface Classifier for Wheelchair Commands Using Neural Network With Fuzzy Particle Swarm Optimization,” Biomedical and Health Informatics, IEEE Journal of, vol. 18, no. 5, pp. 1614, 1624, September 2014.

A preferred embodiment of the invention relates to a method for controlling the motion of a wheelchair for a disabled person. The present invention is of course not limited to such type of mobile apparatus and an application to the control of a car, a plane or a drone for instance is possible. More generally, any mobile apparatus controlled by a user can use said method to move.

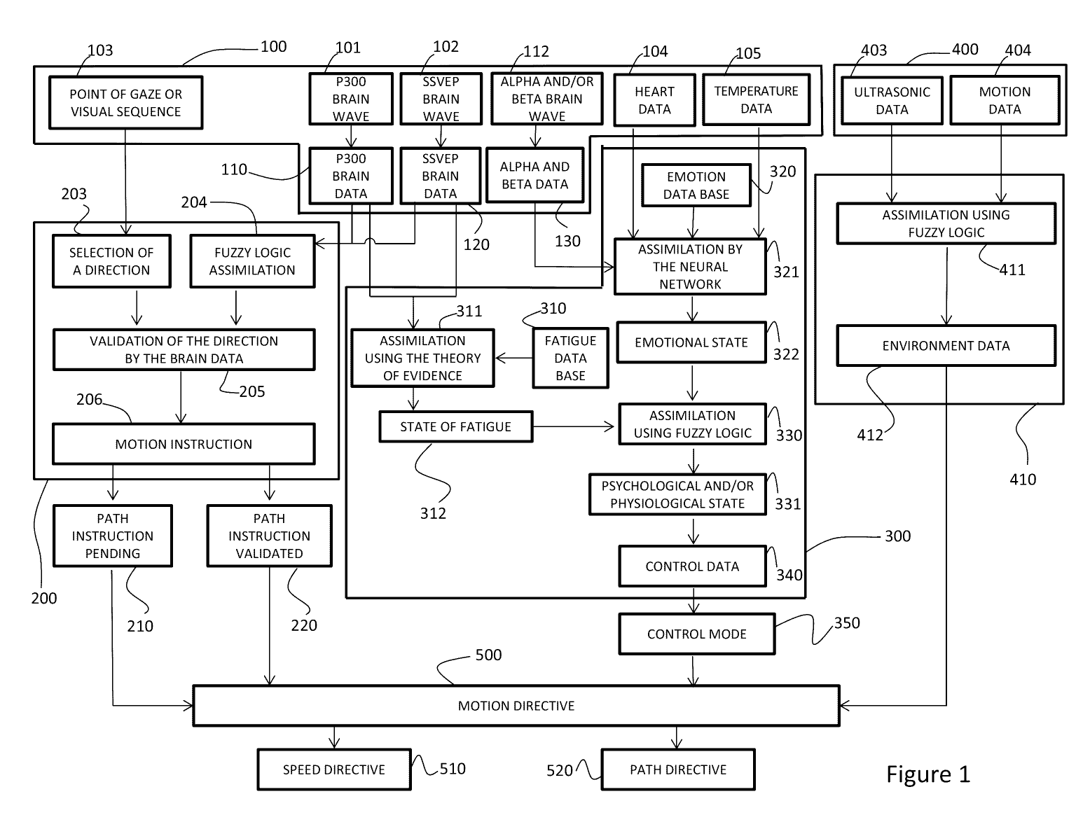

FIG. 1 provides a general view of the invention. The method for controlling the mobile apparatus motion is advantageously based on a motion directive 500. The motion directive 500 more particularly results in generating a path directive 501 and a speed directive 502 which will affect the actual path and the actual speed of the mobile apparatus.

In order to generate said motion directive 500, the method comprises first the acquisition of user's data 100 and space data 400.

User's data 100 comprise at least one of the following data, and preferably all of these: a user's gaze point 103 or a sequence of the user's gaze points, at least one brain data of the P300 110 or SSVEP 120 type, and preferably according to two types of brain waves P300 101 and SSVEP 102 as well as physiological data. Physiological data preferably comprise at least one is among the following data: heart rhythm 104 and temperature 105 data. Other types of data may be added, of course. Brain waves are sensed by at least one EEG (Electroencephalography) sensor 106.

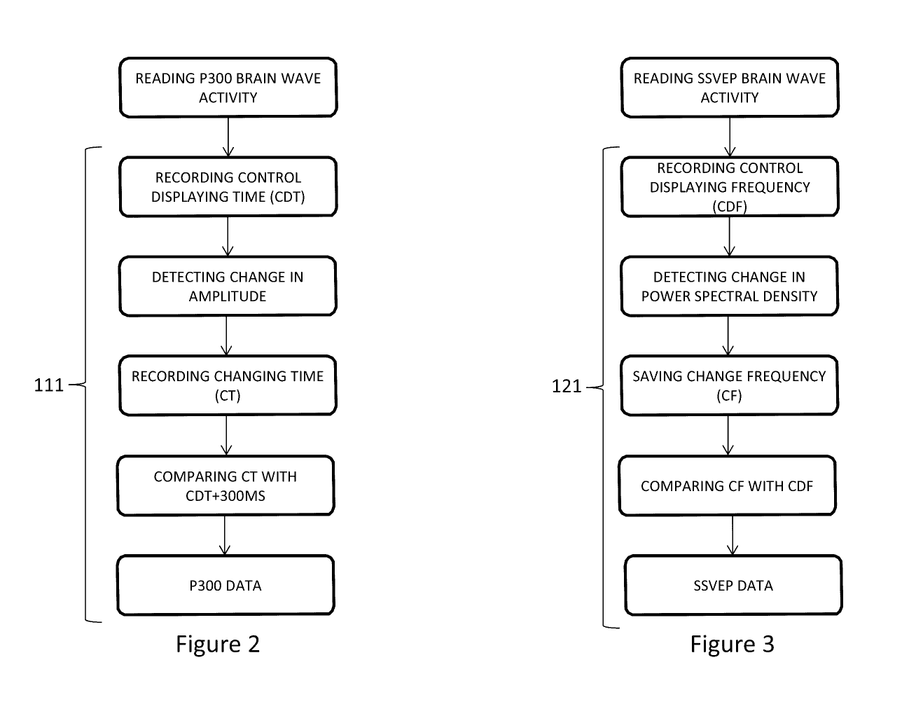

P300 brain data 110 are determined by the difference between the P300 brain waves 101 upon a change in the amplitude. The SSVEP brain data 120 are determined by the difference in the SSVEP brain waves 102 upon the change in the power spectral density thereof (PSDC). To determine the difference in the amplitude of a brain wave of the P300 type 101, the following steps will advantageously be executed:
Reading a brain activity and recording the control displaying time (CDT);
Detection of the change in the amplitude in response to a stimulation and recording the change time (TC);
Comparing CT with CDT+300 ms.
Determination of the difference between CT and CDT+300 ms.
   Such steps are illustrated in FIG. 2.

In order to determine the difference in the change in PSDC of the SSVEP waves 102, the following steps are executed:
Reading a brain activity and recording the control displaying frequency (CDF);
Detection of the change in the PSDC in response to a stimulation and recording the change frequency (CF);
Comparing CF with CDF;

Such steps are illustrated in FIG. 2. Secondly, said user's data 100 and space data 400 will make it possible to generate a motion instruction 206 from a control data 340 and an environment data 412.

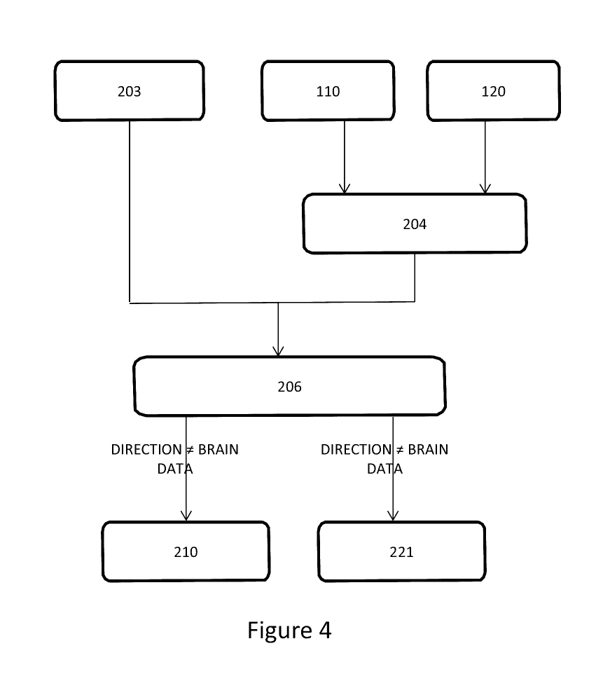

The motion instruction 206 comprises the analysis and the interpretation of said at least one gaze point 103 or the sequence of a user's gaze points and of at least one first and preferably two first brain data of the P300 110 and/or SSVEP 120 types (FIG. 3). Said interpretation of such data makes it possible to generate a validated 210 or not validated 220 path directive which will be integrated into the motion instruction (FIG. 4). Such generation is executed through the step of determining the motion instruction 200.

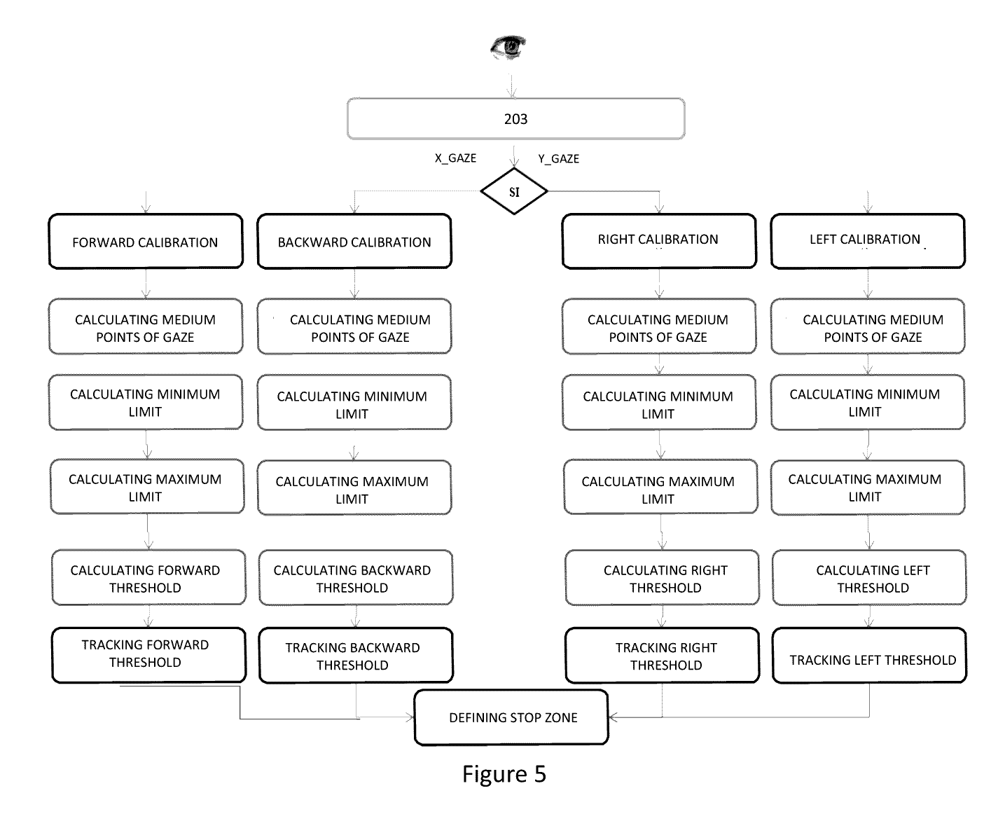

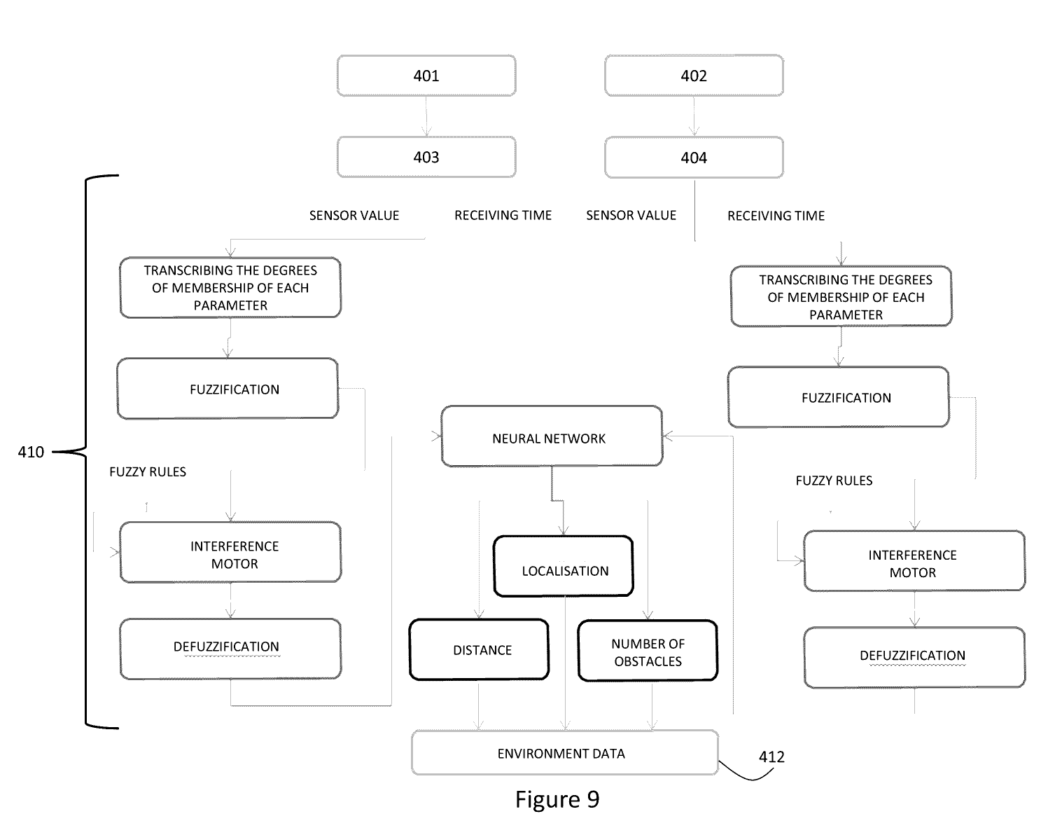

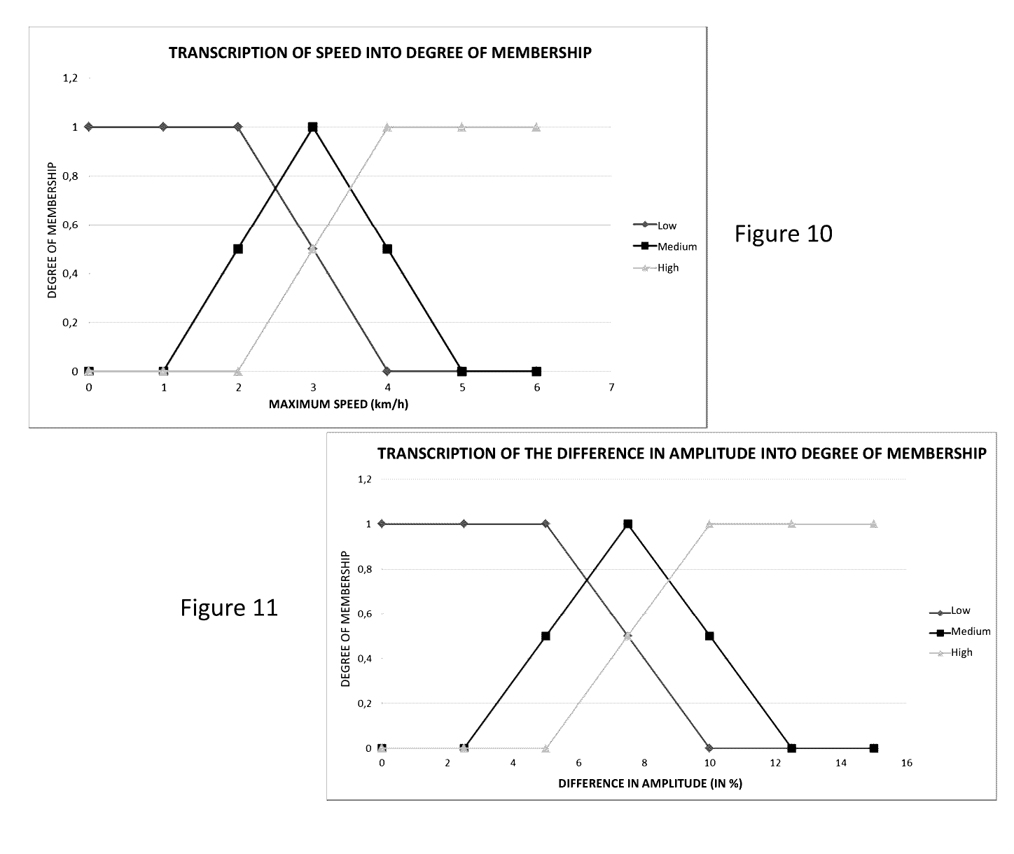

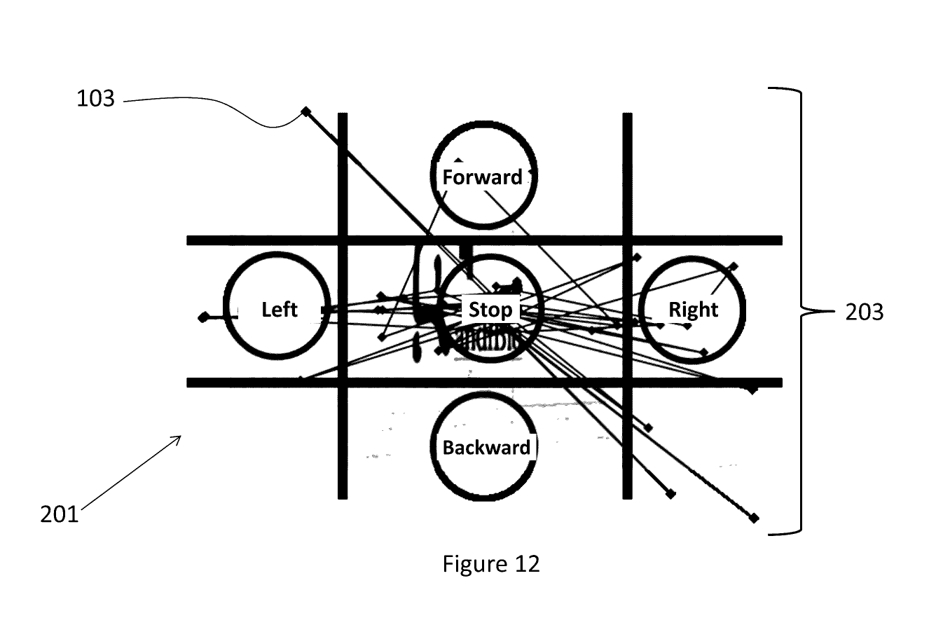

The user's gaze point 103 is acquired by an eye-tracking monitor 107 preferably positioned under the screen 202. In other embodiments, the sensor is positioned above the screen, or in any other position making it possible to optimally detect the user's gaze. The eye-tracking apparatus 107 advantageously makes it possible to detect the user's gaze point on the screen 202. FIG. 5 shows in greater details one embodiment of the operation of the eye-tracking apparatus 107 and the sensing of the user's gaze point 103. Said screen 202 displays at least one grid 201. FIG. 9 shows in greater details the gaze point sequences in the grid 201 (FIG. 12). The grid 201 comprises at least two columns and two rows, and preferably three columns and three rows. Each cell of said grid 201 corresponds to one direction. The direction displayed by one cell of the grid is at least one of the following directions: forward, backward, right, left and stop. Besides, each cell has a specific light frequency.

The light frequency of each one of the grid cells ranges from 10 Hz to 25 Hz. In a preferred embodiment of the invention, a representation of the environment facing the mobile apparatus is displayed behind the grid 201. In order to show the environment facing the apparatus, a first camera is provided on the front face of the mobile apparatus. A second camera is advantageously provided at the back of the mobile apparatus. Such second camera also makes it possible to display the environment behind the rear face of the mobile apparatus. No camera is shown in the figures. Information is displayed on the screen 202 when the mobile apparatus moves backward.

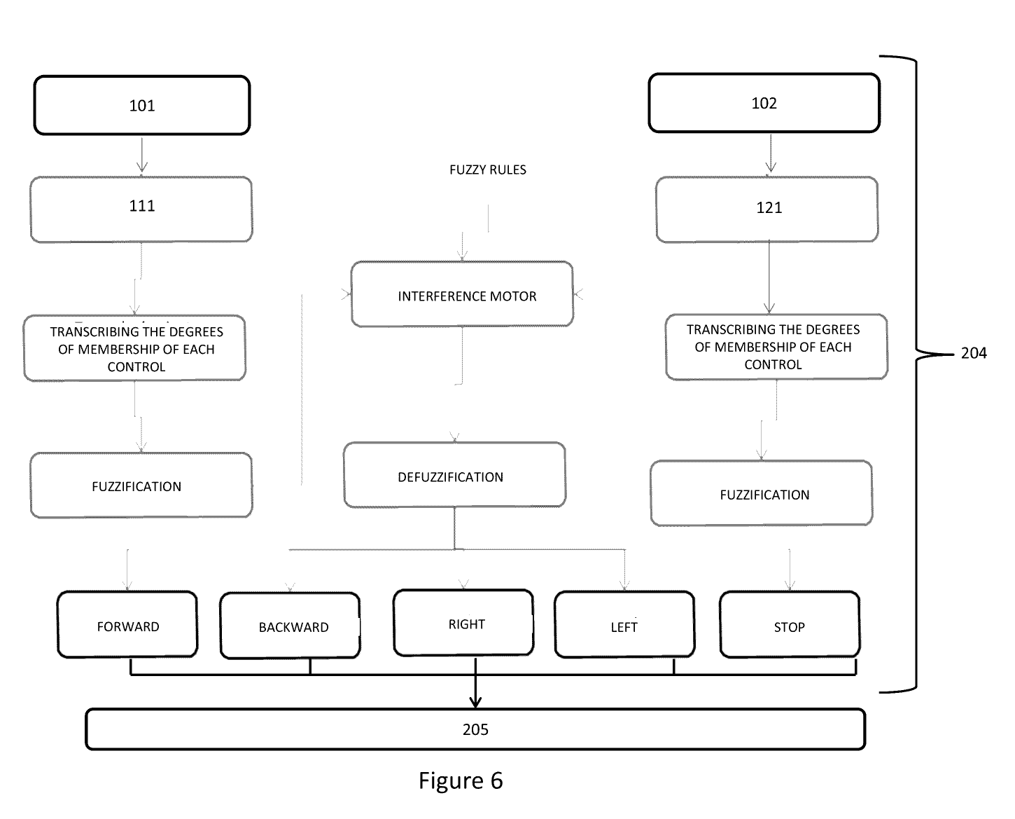

Determining the motion instruction 206 thus comprises the selection, by the user, of a direction 203 displayed in one cell of the grid 201. Selecting a cell in the grid 201 is a stimulation of the brain which will generate a brain wave of the P300 101 type. Besides, as the cell has a specific light frequency, a SSVEP brain wave 102 will also be generated. The P300 101 and SSVEP 102 brain waves will make it possible to determine a first P300 110 and SSVEP 120 brain data. The fuzzy logic system simultaneously takes into account the first two is brain data of the P300 110 and SSVEP 120 type for the motion instruction. An exemplary assimilation of the first P300 and SSVEP 204 data by fuzzy logic is given in FIG. 6.

The interpretation of said first brain data of the P300 110 and SSSVEP 120 types by the fuzzy logic system will make it possible to execute one step of validation 205 of the selected direction 203.

Thus, if the difference between CT and CDT+300 ms is less than or equal to 100 ms and/or the difference between CF and CDF is greater than Y, then the direction is validated by the first SSVEP brain data 110 and/or the first SSVEP data. If the difference between CT and CDT+300 ms is greater than 100 ms and/or the difference between CF and CDF is greater than Y, then the direction is not validated by the first SSVEP brain data 120 and/or the first SSVEP data.

If the direction selected by the user is validated, a path instruction is generated with a validated status.

If the direction selected by the user is not validated, a path directive is generated with a pending status.

Said validated 210 or pending 220 path directive is then integrated into the motion instruction.

The method for validating 205 the selected direction 203 using at least a first brain data of the P300 110 and SSVEP 120 type is illustrated in FIG. 4.

The control data 340 will advantageously make it possible, through the s step of selecting a control mode 350 of the mobile apparatus among the following ones: manual, semi-autonomous and autonomous. In other embodiments, control modes 350 may be added or suppressed. The selected control mode 350 will be integrated in the motion instruction.

Said control data 340 comprises at least one physiological and/or physiological data 331, at least one second brain data of the P300 110 or SSVEP 120 types and/or alpha and/or beta 130 frequency band, at least one pre-recorded data originating from a <<fatigue>> 310 data base and another data originating from an <<emotion>> 320 data base. The control data 340 preferably comprises two user's second brain data of the P300 110 and/or SSVEP 120 and/or alpha and/or beta frequency band 130 types and one physiological and/or psychological 331 data according to the heart rhythm (heart rhythm data 104) and temperature (temperature data 105). Such data, whether combined together or not, make it possible to determine the user's state of fatigue 312 or emotional state 322. The <<fatigue>> data base contains the alpha and beta brain waves as well as the maximum amplitudes and the time of occurrence of

P300 at the EEG sensors.

Advantageously, the first brain data of the P300 110 and/or SSVEP 120 type and the second brain data of the P300 110 and/or SSVEP 120 type originate from the same P300 101 and/or SSVEP 102 brain waves. The <<emotion>> data base preferably contains the standardized variations of the asymmetries of the alpha and beta frequency bands at the parietal, central and frontal regions of the cerebral cortex. Besides, it integrates the changes in the heart rhythm which are correlated with the various emotional states as well as the body temperature data.

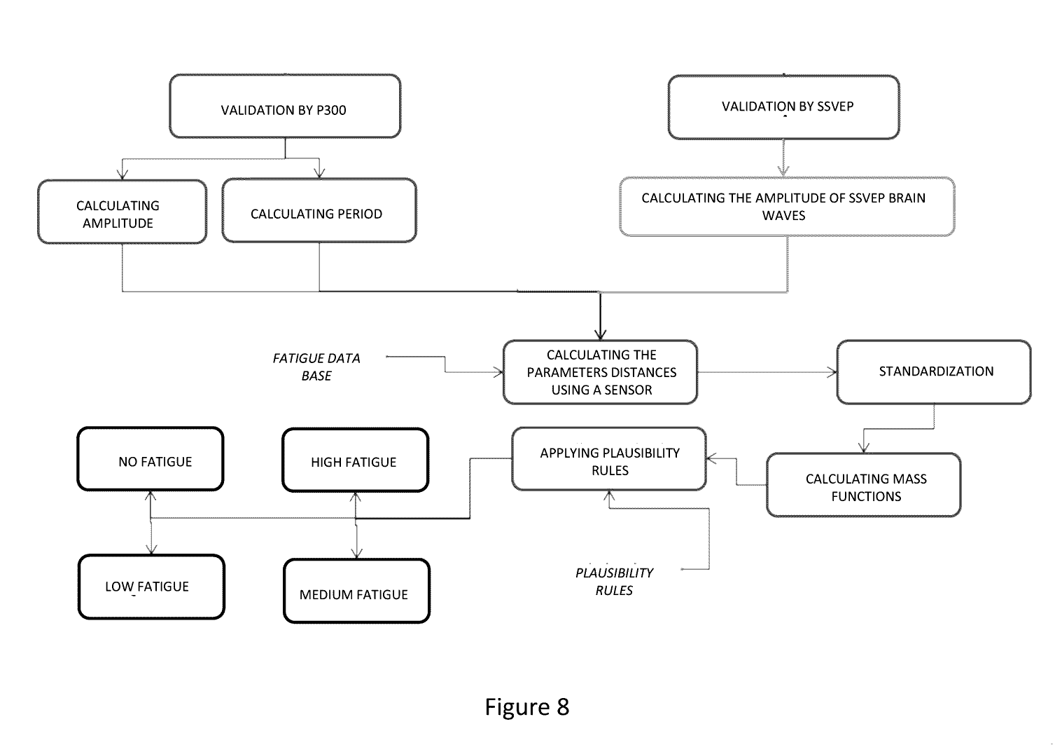

The user's fatigue state 312 advantageously depends on a second P300 110 and/or SSVEP 120 brain data and at least one data pre-recorded in a <<fatigue>> data base 310 Said second P300 110 and/or SSVEP 120 brain data is preferably the same as the first brain data previously used by the motion instruction 206. The interpretation of the difference between CT and CDT+300 ms and/or between CF and CDF and is different. Besides, the simultaneous taking into account 311 of the P300 101 and/or SSVEP 102 brain waves by the control data 340 to determine the fatigue state 312 is executed using the Dempster-Shafer theory or theory of evidence. In such configuration, the difference between these values makes it possible to determine the user's state of fatigue 312. As a matter of fact, a correlation exists between the user's fatigue state and the difference with the maximum amplitude as well as the duration of occurrence of P300 and the noted difference of the CF maximum amplitude. Now, if the difference between the standardized amplitudes of P300 is less than 10% and/or the difference in the amplitudes of the prevailing frequency of SSVEP is less than 15%, a medium fatigue state is determined. In a preferred, but not restrictive, embodiment of the invention, four levels of fatigue can be determined (high, medium, low and no fatigue). In other embodiments of the invention, the number of fatigue levels may vary positively or negatively. Matching the differences in the P300 110 and/or SSVEP 120 brain data and the fatigue state 312 is possible when comparing such differences with the <<fatigue>> data base 310 and integrating plausibility rules. The method for determining the state of fatigue 312 is illustrated in FIG. 8.

An emotional state 322 is advantageously generated too according to the physiological data and the at least one second P300 110 and/or SSVEP 120 brain data and/or one alpha and/or beta 130 data and at least one data pre-recorded in an <<emotion>> data base 320.>>. The evolution of the alpha and/or beta waves 112 over time is correlated with the expressed emotional state. The difference between the standardized amplitude of such waves is once again computed. If the latter increases by 15%, a stress is detected. The user's emotional state 322 can be determined when same are associated with the user's heart rhythm 104 and temperature 105 data. The logic system enabling to interpret and assimilate 321 such multiple data more particularly consists of neural networks. Other theories can of course also be used for interpreting such data.

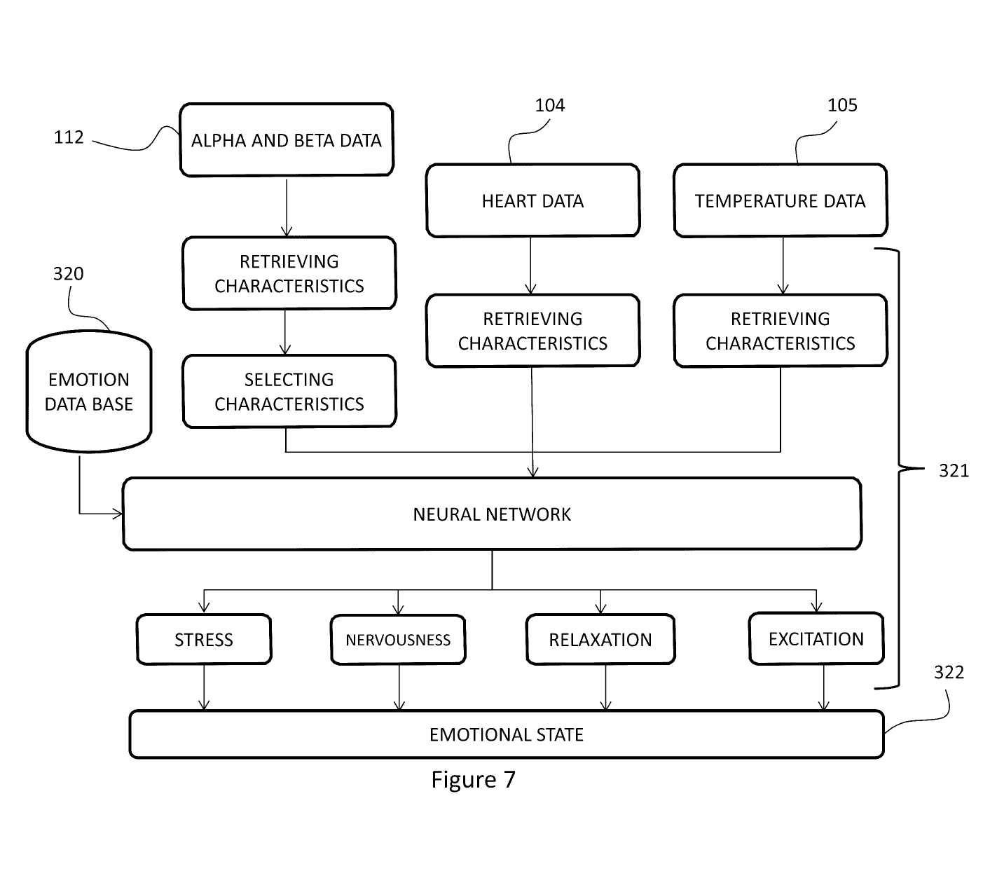

Advantageously, the first brain data of the P300 110 and/or SSVEP 120 type and the second brain data of the P300 110 and/or SSVEP 120 type originate from the same P300 101 and/or SSVEP 102 brain waves. The emotional state 322 is advantageously determined among the following four states: stress, nervousness, relaxation, excitation. The number of present emotional states 322 is not restrictive, and adding or eliminating emotional states is possible. The simultaneous taking into account 321 of the brain data, the physiological data (temperature and heart rhythm) as well as at least one data originating from the <<emotion>> data base 322 is executed by a neural network. Such method for determining the user's emotional state 322 is illustrated in FIG. 7.

Once the user's state of fatigue 312 and emotional state 322 are determined, combining such states 330, using a fuzzy logic system, makes it possible to determine the user's psychological state 331. The control mode 350 is will then be selected according to said user's psychological state 331. Once the control mode 350 is selected, said selection will be integrated in the motion directive.

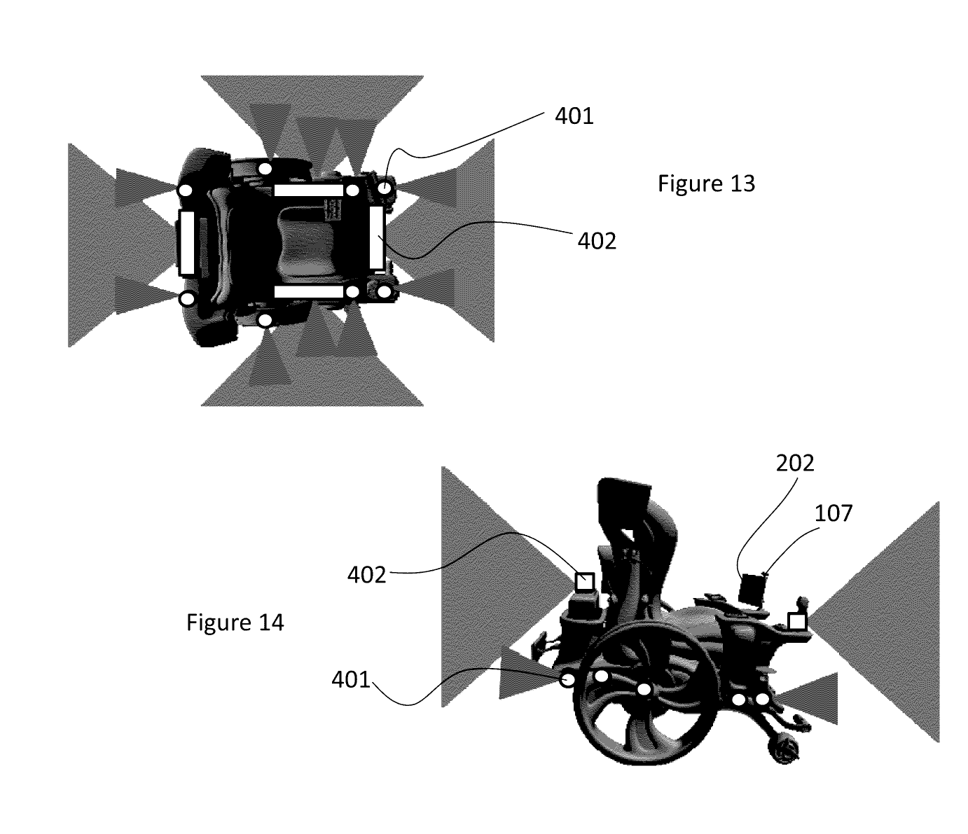

Space data 400 advantageously depends on at least one environment sensor. In one preferred embodiment of the invention at least one environment sensor comprises at least one motion sensor 402 and at least one ultrasonic sensor 401, and preferably four motion sensors 402 and ten ultrasonic sensors 401 (FIGS. 13 and 14). The mobile apparatus preferably comprises three ultrasonic sensors 401 and one motion sensor 402 on each one of the side faces. Two ultrasonic sensors 401 and one motion sensor 402 are positioned on each one of the front and rear faces of the mobile apparatus. When the mobile apparatus is a wheelchair for disabled persons, the ultrasonic sensors 401 are then positioned on the frame of said wheelchair. In this embodiment, the ultrasonic sensors 401 are positioned as close to the ground as possible on the frame. The motion sensors 402 are preferably positioned above the ultrasonic sensors 401. The ultrasonic sensors 401 advantageously make it possible to generate ultrasonic data 403. Said ultrasonic data 403 comprises detecting the number of obstacles and the positions thereof. Computing the localization of the mobile apparatus in an indoor room is possible, using a specific algorithm and the data originating from the ultrasonic sensors 401. Outdoors, the apparatus can be localized by any other means, such as, for s instance a geo-location chip of the satellite type. The maximum range of the ultrasonic sensors 401 advantageously is at least 3 metres and preferably 6 metres. Such advantageous configuration enables to detect the number of obstacles around the mobile apparatus, as well as the distance thereof to said mobile apparatus. The motion sensors 402 make it possible to generate motion data 404. Said motion data 404 makes it possible to detect any activity around the mobile apparatus. The maximum range of said motion sensors 402 advantageously is 2 metres and preferably 4 metres.

The ultrasonic data 403 and the motion data 404 make it possible to locate the apparatus, and to determine the distance thereof to the obstacles and is the number of obstacles. All these elements define the environment data 412. Said environment data 412 is then integrated into the motion directive.

Eventually, the data originating from the various types of ultrasonic 401 and motion 402 sensors are assimilated by a fuzzy logic system 411 disclosed in FIG. 9. Such step of assimilating ultrasonic 403 and motion data 404 for determining the environment data is block 410 in FIG. 9.

The motion directive process and then analyses the validated 210 or non validated 220 path directive, the control mode 350 as well as the environment data 412. To process such information, it advantageously comprises a computer (preferably a microprocessor and/or a programmable logic circuit (or FGPA)) and an internal memory. In another embodiment of the invention, the computer is outset and the motion directive 500 only is sent to the mobile apparatus to be applied. Such data are processed using a fuzzy logic system so as to determine a motion speed 501 as well as a motion path 502 (FIGS. 11 and 12)

Speed can advantageously be determined by two methods: either using encoders mounted on the wheelchair or using the data originating from the motion sensors 402 of the ultrasonic sensors 401. The mobile apparatus thus moves at a default maximum speed, in a preferred embodiment of the invention. A speed reduction coefficient is then applied according to the received data. The sensor detecting the apparatus speed is preferably an odometer. Other s speed sensors may be added, of course. In another embodiment of the invention, no default speed is used. Speed is then determined by the position of the at least one gaze point or visual sequence 103 in the grid 201.

Taking into account all such data makes it possible to sharpen the motion directive 500. For example, if the user is tired, the mobile apparatus will determine an autonomous control mode 350, and enable the validation of the <<pending >> directions 210. Taking into account the state of fatigue 312 makes it possible to correct such data and makes all motions easier. Similarly, in an obstacle is present, the ultrasonic sensor 401 enables the automatic bypassing, or U-turning of the mobile apparatus. The user will thus not be stuck by the is obstacle.

When reading the above description, it clearly appears that the invention provides a particularly efficient solution to control a mobile apparatus in a precise, reliable and comfortable way, for the user. The mobile apparatus will then be possibly operated during much longer time intervals than in the other known solutions.

The invention is not limited to the embodiments described above but applies to any embodiment complying with the spirit of the claims.

### REFERENCES

100. User's data
101. P300 brain wave;
102. SSVEP brain wave;
103. User's gaze point;
104. Heart data;
105. Temperature data;
106. Electroencephalographic sensor;
107. Eye-tracking apparatus;
108. Heart-rate monitor;
109. Thermometer;
110. P300 brain data;
111. Determination of P300 brain data;
112. Alpha and/or Beta brain wave
120. SSVEP brain data;
121. Determination of SSVEP brain data;
130. Alpha and/or Beta brain data
200. Determination of motion instruction data;
201. Grid;
202. Screen
203. Selection of one direction by the user;
204. Assimilation of P300 and SSVEP data;
205. Validation of the direction selected by the brain data;
206. Motion instruction
210. determination of a validated path directive;
220. determination of a pending path directive;
300. Step of determining the control data;
310. “fatigue” data base
311. Assimilation with the theory of evidence
312. Fatigue state
320. “emotion” data base
321. Assimilation with the theory of evidence
322. Emotional state;
330. Assimilation with fuzzy logic;
331 Psychological and/or physiological state
340. Control data;
350. Control mode;
400. Space data
401. Ultrasonic sensor;
402. Motion sensor;
403. Ultrasonic data;
404. Motion data;
410. Determination of motion data;
411. Assimilation of environment with fuzzy logic;
412. Environment data
500. Motion directive,
510. Speed directive;
520. Path directive.

1. A method for controlling the motion of a mobile apparatus by a user, wherein the motion control is based on a motion directive, comprising a step of determining said motion directive, wherein such step of determination comprises the following steps implemented by a computer assisted by at least one microprocessor:
Generation of at least one motion instruction based at least on:
at least one direction originating from the user's gaze point,
at least one first user's brain data, with said brain data originating from a user's positive brain wave, also called P300 brain wave, which appears 300 ms (millisecond) after a stimulation and/or originating from a user's brain wave, also called SSVEP brain wave, which appears in response to a predetermined visual stimulation;
Generation of at least one control data, at least based on:
a second user's brain data originating from a P300 brain wave, and/or originating from a SSVEP brain wave and/or a brain wave of the alpha and/or beta type at the parietal, central and frontal region of the cerebral cortex.
a physiological data among at least the user's temperature and/or heart rhythm;
Generation of at least one environment data from at least one sensor identifying at least one part of the environment of the mobile apparatus;
Generation of a motion directive according to at least: said motion instruction, said control data and said environment data.
Generation of a path directive and a speed directive according to said motion directive, specifically.

2. A method according to claim 1, wherein the motion instruction determines a path instruction among at least one or a combination of the following directions: forward, backward, right, left, stop, with the path directive depending on the path instruction too.

3. A method according to claim 2, wherein said step of generating the motion instruction comprises a validation of the at least one direction originating from the user's gaze point through the at least one first brain data, so as to determine the path instruction.

4. A method according to claim 1, wherein the first and/or second brain data originates from a P300 brain wave and comprises a step of generating the first and/or second brain data originating from the P300 brain wave, comprising the following steps:
Reading a user's brain activity while recording the control displaying time (CDT);
Detecting the P300 brain wave from the change in the amplitude of the brain activity and recording the changing time (CT);
Comparing CDT with CT;
Generating the first and/or second brain data, called P300 brain data, originating from one P300 brain wave.

5. A method according to claim 4, wherein the motion instruction determines a path instruction, wherein said step of generating the motion instruction comprises the validation of the at least one direction originating from at least a user's gaze point by the at least one first brain data, in order to determine the path instruction, wherein said first brain data originates from a P300 brain wave, and wherein the step of validation by the at least one first brain data, comprises the following steps:
If the difference between CT and CDT+300 ms (10⁻³ seconds) is less than or equal to 100 ms the path instruction is then transmitted to the motion directive with a validated status;
If the difference between CT and CDT+300 ms is more than 100 ms the path instruction is then transmitted to the motion directive with a pending status.

6. A method according to claim 1, wherein the first and/or second brain data originates from a SSVEP brain wave and comprises a step of generating the first and/or second brain data originating from the SSVEP brain wave, comprising the following steps:
Appearing of controls with pre-set frequencies (between 10 and 25 Hz) (CDF);
Detection of the change in the amplitude of the brain activity and recording the change of frequency (CF);
Comparing CDF with CF;
Generating the first and/or second brain data, also called SSVEP brain data, originating from one SSVEP brain wave.

7. A method according to claim 6, wherein the motion instruction determines a path instruction, wherein said step of generating the motion instruction comprises the validation of the at least one direction originating from at least a user's gaze point by the at least one brain data, in order to determine the path instruction, wherein said first brain data originates from a SSVEP brain wave, and wherein the step of validation by the at least one first brain data, comprises the following steps:
If the difference between CF and CDF is less than or equal to 10% the path instruction is then transmitted to the motion directive with a validated status;
If the difference between CF and CDF is more than 10% the path instruction is then transmitted to the motion directive with a pending status;

8. A method according to claim 3, wherein the step of generating the motion instruction comprises the validation of the at least one direction originating from at least one user's gaze point and wherein the first and/or second brain data originates from a P300 brain wave and is called P300 brain data and wherein the first and/or second brain data originates from a SSVEP brain wave and is called a SSVEP brain data, with said validation occurring according to the at least one P300 brain data and the at least one SSVEP brain data, with the at least two P300 and SSVEP brain data being simultaneously taken into account by a fuzzy logic system.

9. A method according to claim 1 comprising a step of selecting a control mode among the following ones: manual, semi-autonomous and autonomous, with the motion directive depending specifically on the selected control mode, with said selection of the control mode being based on said at least one control data.

10. A method according to claim 9, wherein generating at least one control data comprises determining a user's psychological and/or physiological state, with said psychological and/or physiological state depending on said user's emotional or fatigue states.

11. A method according to claim 10, wherein generating the first and/or second brain data, also called SSVEP brain data, originates from a SSVEP brain wave and/or generating the first and/or second brain data, also called P300 brain data originates from a P300 brain wave, and wherein the user's psychological and/or physiological state depends on a fatigue state, with said fatigue state being more particularly determined through the interpretation of the second brain data, with said second brain data being the P300 brain data and/or the SSVEP brain data.

12. A method according to claim 11, wherein the user's fatigue state is determined by a pre-determination originating from the at least one brain data of the P300 and/or SSVEP type, and by at least one data pre-recorded in a “fatigue” data base, and by applying the theory of evidence comprising the application of plausibility rules.

13. A method according to claim 1, wherein said second brain data originates from a brain wave of the alpha and/or beta type taken at the parietal, central and frontal area of the cerebral cortex and wherein said generation of at least one control data also comprises determining a user's psychological and/or physiological state, with said user's psychological and/or physiological state depending on said user's emotional state and wherein the user's emotional state is determined according to physiological data comprising at least the user's temperature and/or the user's heart rhythm, and the at least second brain data originating from a brain wave of the beta and/or alpha type called alpha and/or beta brain wave, and at least one data pre-recorded in an “emotions” data base, with said determination being executed by a neural network.

14. A method according to claim 10, wherein the user's psychological and/or physiological state is determined by a fuzzy logic system taking into account the user's fatigue and/or emotional states.

15. A method according to claim 1, wherein the at least one sensor is so configured as to enable the detection of the distance between the apparatus and obstacles positioned close to the apparatus and/or to enable the localisation of the apparatus.

16. A method according to claim 15, wherein said environment data originates from several types of sensors and the data from each type of sensor are processed by a fuzzy logic system, with the processed data being interpreted afterwards by a neural network making it possible to determine the location and/or the distance of the apparatus relative to the obstacles, as well as the number of obstacles surrounding said apparatus.

17. A mobile apparatus the motion of which is controlled by the method according to claim 1, comprising various types of sensors so configured as to detect at least one user's gaze point, one user's brain data and one physiological data, as well as space data relative to the environment of the mobile apparatus.

18. The mobile apparatus according to claim 17, wherein.
the at least first brain data is sensed by an EEG sensor (electroencephalography), with said EEG sensor being so configured as to detect and/or record at least one P300 and/or SSVEP brain wave.
the at least second user brain data originates from a user's positive brain wave, called a P300 brain wave, appearing 300 ms (milliseconds) after a stimulation and/or originates from a user's brain wave, called a SSVEP brain wave, appearing in response to a predetermined visual stimulation and/or originates from an alpha and/or beta wave is sensed by an EEG sensor (electroencephalography), with said EEG sensor being so configured as to detect and/or record at least one of the user's P300 and/or SSVEP and/or alpha and/or beta waves.

19. A mobile apparatus according to claim 17, comprising a screen so configured as to display a grid comprising directions and wherein each direction in the grid displays a different light frequency.

20. A mobile apparatus according to claim 19, wherein said at least one user's gaze point is sensed by an eye-tracking apparatus so configured as to sense and/or record the gaze point of at least one of the user's irises when the user looks at the screen.

21. A mobile apparatus according to claim 17, wherein at least one user's physiological data originates from a thermometer and/or a heart-rate monitor so configured as to detect and record said user's temperature and heart rhythm, respectively.

22. A mobile apparatus according to claim 17, wherein the environment data originate from at least one ultrasonic sensor and from at least one motion sensor so configured as to localise the mobile apparatus as well as the distance thereof from the surrounding objects.

23. A mobile apparatus according to claim 22 having at least one front face, one rear face and two side faces and comprising ten ultrasonic sensors positioned as indicated hereunder:
two sensors on each one of the front and rear faces of the mobile apparatus;
three sensors on each one of the side faces of the mobile apparatus;

24. A mobile apparatus according to claim 22 having at least one front face, one rear face and two side faces and comprising four motion sensors positioned on each one of the front, rear, and side faces of the mobile apparatus.
